(19) United States
(12) Patent Application Publication
(10) Pub. No.: US 2009/0146887 A1
(43) Pub. Date: Jun. 11, 2009

(54) Reduced Volume Antennas

(76) Inventor: Rehan JAFFRI, New York, NY (US)

Correspondence Address: Fay Kaplun & Marcin, LLP/ Motorola, 150 Broadway Suite 702, New York, NY, 10038, US

(21) Appl. No.: 11/950,903

(22) Filed: Dec. 5, 2007

(51) Int. Cl. H01Q 1/24; H01Q 21/00

(52) U.S. Cl. 343/702; 343/893

(57) ABSTRACT

A device includes (a) a first wireless communications arrangement which is capable of at least one of transmitting and receiving. In addition, the device includes (b) a first antenna coupled to the first wireless communications arrangement and (c) a second wireless communications arrangement which is capable of at least one of transmitting and receiving. Furthermore, the device includes (d) a second antenna coupled to the second wireless communications arrangement. The second antenna acts as a parasitic element for the first antenna.

### FIELD OF THE INVENTION

The present invention relates generally to devices that contain multiple antennas.

### BACKGROUND

Modern mobile computing devices are typically capable of carrying out communications using a plurality of different wireless protocols. Different types of wireless communication require separate antennas. These different types of antennas each take up space within the mobile computing device. Since mobile computing devices have a limited amount of space, the addition of more wireless communications protocols becomes difficult because of space constraints.

### SUMMARY OF THE INVENTION

The present invention relates to reduced volume antennas. The antenna device includes (a) a first wireless communications arrangement which is capable of at least one of transmitting and receiving. In addition, the device includes (b) a first antenna coupled to the first wireless communications arrangement and (c) a second wireless communications arrangement which is capable of at least one of transmitting and receiving. Furthermore, the device includes (d) a second antenna coupled to the second wireless communications arrangement. The second antenna acts as a parasitic element for the first antenna.

### BRIEF DESCRIPTION OF THE DRAWINGS

FIG. 1 shows a first device including an exemplary antenna according to the present invention.

FIG. 2 shows a second device including an exemplary antenna according to the present invention.

FIG. 3 shows a third device including an exemplary antenna according to the present invention.

### DETAILED DESCRIPTION

The exemplary embodiments of the present invention may be further understood with reference to the following description and the appended drawings, wherein like elements are referred to with the same reference numerals. The exemplary embodiments of the present invention describe devices that minimize the space requirements of multiple antennas.

A “device,” as used in this disclosure, may refer to any type of device that may send or receive signals through the use of an antenna. For example, the device may be a handheld computer, a notebook computer, a personal digital assistant (“PDA”), a scanner, a mobile telephone, a data acquisition device, a camera, a pager, etc. Though the exemplary embodiments of the present invention may refer specifically to mobile computing devices, as such devices may greatly benefit from reducing the overall amount of space devoted to antennas, the broader principles of the present invention are equally applicable to any other type of device that may include a plurality of antennas.

An “antenna” is a transducer used to transmit and receive radio waves. Though the exemplary embodiments described below will refer to specific types of antennas, those of skill in the art will understand that the same principles are applicable to antennas used for any purpose. Many types of antennas use “parasitic elements,” which are antenna elements that do not have any wired input or output, but either reflect or absorb and re-radiate radio waves sent to or from an active antenna element in proximity to the parasitic element. The use of parasitic elements improves the performance of antennas. The same effect can be achieved by the addition of lumped elements (e.g., capacitors or inductors) to the antenna, but this can result in losses. However, the use of parasitic elements and lumped elements takes up additional space within a device.

Modern mobile computing devices may communicate wirelessly using a plurality of communication protocols. For example, a mobile device may be able communicate with a wireless local area network (“WLAN”), a wireless wide area network (“WWAN”), one or more peripherals using the Bluetooth protocol, a global positioning system (“GPS”), a radio frequency identification (“RFID”) protocol, etc. In prior embodiments of such devices, the antennas for each of these are separated from each other and occupy considerable volume within the device. This is challenging given the small form factor of mobile devices, and makes it difficult to further decrease the size of such devices.

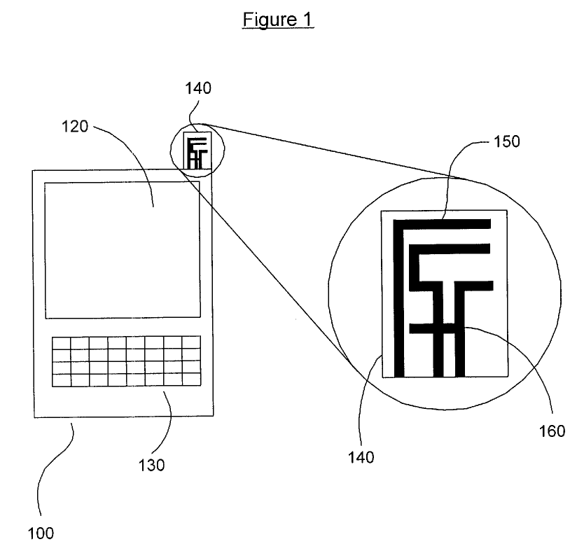

FIG. 1 shows a first exemplary embodiment of a device 100 according to the present invention. The device 100 may be, for example, a mobile computing device of the types described above, but may also be any other type of device that may include two or more antennas. The device 100 includes one or more wireless transceivers/receivers (not shown), which may include, for example, an 802.11 transceiver, a Bluetooth transceiver, a GPS receiver, etc. The exemplary device 100 also includes a display 120 and an input means 130 (e.g., a keypad, etc.). Those of skill in the art will understand that other exemplary devices may lack one or both of these components and may also include other types of components. The device 100 also includes an antenna housing 140.

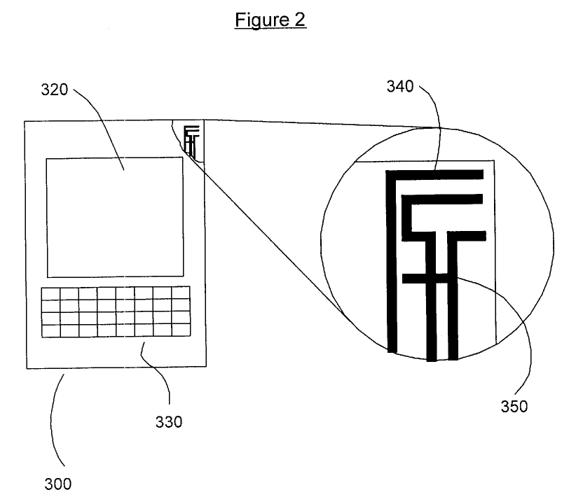

FIG. 1 also shows a detailed view of the antenna housing 140 of the device 100. The antenna housing 140 contains a pair of antennas 150 and 160. The antennas 150 and 160 are located proximately to one another; the exact proximity may vary among embodiments of the present invention depending on the purposes for which the antennas 150 and 160 are being used. Those of skill in the art will understand that while FIG. 1 illustrates an antenna housing 140 and antennas 150 and 160 of specific shapes and in specific locations, these shapes and locations are only illustrative and the shapes and locations may vary among embodiments of the present invention. Further, those of skill in the art will understand that while FIG. 1 illustrates an exemplary embodiment with antennas 150 and 160 within a housing 140, other embodiments of the present invention may lack a dedicated antenna housing. FIG. 2 illustrates such an embodiment.

By locating the antennas 150 and 160 proximately to one another, the antenna 160 may act as a parasitic element for the antenna 150, and vice versa. In other words, as described above, the antenna 160 may act as a capacitive element to reflect or absorb and re-radiate radio waves that have been sent to or from the antenna 150, while the antenna 150 does the same for radio waves sent to or from the antenna 160. Those of skill in the art will understand that the radio waves may interfere with one another if they are transmitted on similar frequency bands; thus, acceptable isolation may be achieved by using the antennas 150 and 160 for communication on frequency bands that are suitably different from one another. Meeting the technical specification for an acceptable isolation is an important factor for practical implementation of the exemplary embodiments of the present invention. This ensures reduced interference between the antennas 150 and 160 (in this case, working at different frequencies) connected to their respective transceivers/receivers.

Those of skill in the art will understand that the antennas 150 and 160 must be located close enough to one another that they are capable of acting as parasitic elements for one another, providing the right amount of coupling. The precise proximity required will depend on the amount of coupling required between the antennas 150 and 160 and depends on the individual designs of the antennas 150 and 160. For example, if the antenna 150 is a Bluetooth antenna operating in a frequency range appropriate for Bluetooth functionality (e.g., 2.4 GHz to 2.4835 GHz), and the antenna 160 is a GPS antenna operating on a frequency appropriate for GPS functionality (e.g., 1176.45 MHz, 1227.60 MHz, 1379.913 MHz, 1381.05 MHz or 1575.42 MHz), they may be placed a first distance from one another, while if the antenna 150 is an 802.11 antenna operating in a frequency band appropriate for 80:2.11 communication (e.g., 2.4 GHz to 2.5 GHz) and the antenna 160 is an WWAN antenna operating at a frequency appropriate for WWAN communication (e.g., 850 MHz, 900 MHz, 1800 MHz, 1900 MHz), they may be placed a second distance from one another. The first and second distances may or may not be the same.

FIG. 2 illustrates a second exemplary embodiment of a device 300 according to the present invention. Like the device 100 of FIG. 1, the device 300 may be, for example, a mobile computing device of the types described above, but may also be any other type of device that may include two or more antennas. The device 300 includes one or more wireless transceivers/receivers (not shown), which may include, for example, an 802.11 transceiver, a Bluetooth transceiver, a GPS receiver, etc. The exemplary device 300 also includes a display 320 and an input means 330 (e.g., a keypad, etc.), but as above, those of skill in the art will understand that other exemplary devices may lack one or both of these components, and may include other types, of components.

FIG. 2 also illustrates a detailed cutaway view of a portion of the device 300. The device 300, like the device 100, includes two antennas 340 and 350 that are located proximately to one another. However, the device 300 lacks a dedicated antenna housing; rather, the antennas 340 and 350 are located within the main housing of the device 300. As discussed above with reference to the exemplary embodiment of FIG. 1, those of skill in the art will understand that the specific shapes and locations of the antennas 340 and 350 shown in FIG. 2 are only exemplary, and that the precise shapes and locations of the antennas may vary among embodiments of the present invention.

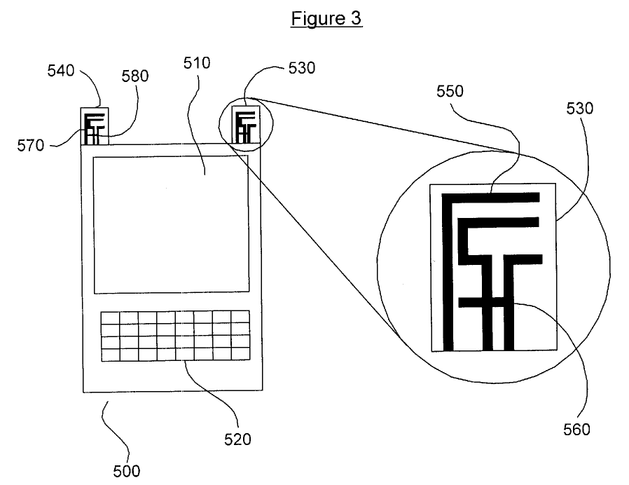

FIG. 3 illustrates another exemplary device 500 according to the present invention. The exemplary device 500 is similar to the device 100 of FIG. 1 and includes one or more wireless transceivers/receivers (not shown), a display 510 and an input means 520. However, the device 500 includes two antenna housings 530 and 540. Each of the antenna housings 530 and 540 contains a pair of antennas selected and disposed to act as parasitic elements for one another, as described above.

FIG. 3 also illustrates a detailed view of the antenna housing 530, which contains antennas 550 and 560. As discussed above with reference to FIGS. 1 and 2, the illustrated designs and positions of the antennas 550 and 560 are only exemplary, and may vary among embodiments of the present invention. The antenna housing 540 contains antennas 570 and 580 (not shown in expanded detail). The antennas 570 and 580, as illustrated in FIG. 3, may be substantially similar in design (though tuned to different frequencies) to the antennas 550 and 560, or may be dissimilar to the antennas 550 and 560. Those of skill in the art will understand that the antennas 570 and 580 may be used for different purposes and thus may differ in both design and orientation from the antennas 550 and 560.

FIGS. 1-3 illustrate various exemplary embodiments including a device 100 including two antennas within a separate antenna housing, a device 300 including two antennas within the main housing of the device, and a device 500 including two pairs of antennas within two separate antenna housings. However, those of skill in the art will understand that other potential embodiments of the present invention may include a device with two pairs of antennas disposed within the main housing of the device; a device with one pair of antennas disposed within the main housing of the device and one pair of antennas disposed within a separate antenna housing; and devices with more than two pairs of antennas disposed within the main housing of the device, within separate antenna housings, or a combination of the two.

The exemplary embodiments of the present invention aid in the design of devices including multiple antennas by making it possible to simultaneously improve the performance of the antennas and conserve space within the devices. As discussed above, conserving space is of particular importance in modern mobile computing devices. By the implementation of these exemplary embodiments, multiple antennas can be located in close proximity to one another, improving the performance of both in confined space while eliminating the need for passive elements that serve no other function.

The above described exemplary embodiments refer specifically to devices using exactly two antennas acting as parasitic elements for one another. However, those of skill in the art will understand that other embodiments that incorporate antennas configured in groups of more than two are also possible. For example, in another exemplary embodiment, an antenna housing may contain three antennas, all of which operate on frequencies that differ sufficiently so as to not interfere with one another, and all of which are spaced at appropriate distances from one another to act as parasitic elements for one another as described above. Other exemplary embodiments may include differing numbers of antennas selected and placed in similar manners.

The present invention has been described with reference to the above specific exemplary embodiments. However, those of ordinary skill in the art will recognize that the same principles may be applied to other embodiments of the present invention, and that the exemplary embodiments should therefore be read in an illustrative, rather than limiting, sense.

What is claimed is:

1. A device, comprising:
a first wireless communications arrangement, the first wireless communications arrangement being capable of at least one of transmitting and receiving;
a first antenna coupled to the first wireless communications arrangement;
a second wireless communications arrangement, the second wireless communications arrangement being capable of at least one of transmitting and receiving; and
a second antenna coupled to the second wireless communications arrangement,
wherein the second antenna acts as a parasitic element for the first antenna.

2. The device of claim 1, wherein the first antenna acts as a parasitic element for the second antenna.

3. The device of claim 1, wherein the first antenna is one of a WLAN antenna, a WWAN antenna, a Bluetooth antenna, a GPS antenna and an RFID antenna.

4. The device of claim 1, further comprising:
an antenna housing disposed externally to a housing of the device,
wherein the first antenna and the second antenna are disposed within the antenna housing.

5. The device of claim 1, wherein the first antenna and the second antenna are disposed within a housing of the device.

6. The device of claim 1, further comprising:
a third wireless communications arrangement, the third wireless communications arrangement being capable of at least one of transmitting and receiving;
a third antenna coupled to the third wireless communications arrangement;
a fourth wireless communications arrangement, the fourth wireless communications arrangement being capable of at least one of transmitting and receiving; and
a fourth antenna coupled to the fourth wireless communications arrangement,
wherein the fourth antenna acts as a parasitic element for the third antenna.

7. The device of claim 6, wherein the third antenna acts as a parasitic element for the fourth antenna.

8. The device of claim 6, further comprising:
a first antenna housing disposed externally to a housing of the device,
wherein the first and second antennas are disposed within the first antenna housing.

9. The device of claim 8, further comprising:
a second antenna housing disposed externally to a housing of the device,
wherein the third and fourth antennas are disposed within the second antenna housing.

10. The device of claim 6, wherein the third antenna is one of a WLAN antenna, a WWAN antenna, a Bluetooth antenna and a GPS antenna.

11. The device of claim 6, further comprising:
a fifth wireless communications arrangement, the fifth wireless communications arrangement being capable of at least one of transmitting and receiving;
a fifth antenna coupled to the fifth wireless communications arrangement;
a sixth wireless communications arrangement, the sixth wireless communications arrangement being capable of at least one of transmitting and receiving; and
a sixth antenna coupled to the sixth wireless communications arrangement,
wherein the sixth antenna acts as a parasitic element for the fifth antenna.

12. The device of claim 11, wherein the fifth antenna acts as a parasitic element for the sixth antenna.

13. The device of claim 11, wherein the fifth antenna is one of a WLAN antenna, a WWAN antenna, a Bluetooth antenna and a GPS antenna.

14. The device of claim 11, further comprising:
a first antenna housing disposed externally to a housing of the device,
wherein the first antenna and the second antenna are disposed within the first antenna housing.

15. The device of claim 14, further comprising:
a second antenna housing disposed externally to a housing of the device,
wherein the third antenna and the fourth antenna are disposed within the second antenna housing.

16. The device of claim 15, further comprising:
a third antenna housing disposed externally to a housing of the device,
wherein the fifth antenna and the sixth antenna are disposed within the third antenna housing.

17. The device of claim 1, further comprising:
a third wireless communications arrangement, the third wireless communications arrangement being capable of at least one of transmitting and receiving; and
a third antenna coupled to the third wireless communications arrangement,
wherein the third antenna acts as a parasitic element for the second antenna.

18. An arrangement, comprising:
a first antenna radiating a first signal at a first frequency; and
a second antenna radiating a second signal at a second frequency,
wherein the second antenna acts as a parasitic element for the first antenna when the first antenna is radiating the first signal.

19. The arrangement of claim 18, wherein the first antenna acts as a parasitic element for the second antenna when the second antenna is radiating the second signal.

20. A device, comprising:
a first means for performing one of generating and wirelessly transmitting a first signal and wirelessly receiving a first signal; and.
a second means for performing one of generating and wirelessly transmitting a second signal and wirelessly receiving a second signal,
wherein the second means acts as a parasitic element for the first means.
